(19) United States
(12) Patent Application Publication
(10) Pub. No.: US 2003/0036034 A1
(43) Pub. Date: Feb. 20, 2003

(54) Intraosseous anaesthesia delivery system

(76) Inventor: G. Cyril Kay, London (GB)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/202,012

(22) Filed: Jul. 25, 2002

(30) Foreign Application Priority Data
Jul. 25, 2001 (GB) GB 0118078.5

(51) Int. Cl. A61C 3/00

(52) U.S. Cl. 433/141; 433/80

(57) ABSTRACT

A guide sleeve device for use in insertion of a dental injection needle into a perforation in a cortical bone of a dental patient. A holding member includes a finger grip part and a funnel part. The funnel part opening includes a conical portion within the funnel part flared portion and a cylindrical portion within the funnel part cylindrical portion. A guide sleeve includes a flared part and a tubular part and has an opening through it with a conical portion within the guide sleeve flared part and a cylindrical portion within the guide sleeve tubular part. The guide sleeve is within the funnel part opening with the guide sleeve flared part within the conical portion of the funnel part opening and with the guide sleeve tubular part within the cylindrical portion of the funnel part opening. A retainer retains the guide sleeve within the holding member funnel part opening.

### FIELD

This invention relates to improvements in intraosseous anaesthesia delivery systems. More particularly, this invention relates to an improved guide-sleeve device, enabling a dentist to readily insert a dental injection needle into a perforation that has been drilled in a patient's cortical bone so as to inject anaesthetic.

### BACKGROUND

An intraosseous anaesthesia delivery system, known under the trade mark Stabident, in accordance with U.S. Pat. Nos. 5,057,013 and 5,173,050 has been known and used since the early 1990s. In this system, a perforator consists of a 27 gauge wire, which may be solid, bevelled at one end, and secured at the other end to a plastic shank by, for example, insert moulding. The plastic shank at its end remote from the wire is formed with a flat and a part-annular groove for latching in a latch-type contra-angle handpiece.

The standard dental injection-needle is bevelled at the free end, the bevel terminating in a sharp point. This arrangement is designed to enable the dentist to slide the needle painlessly just beneath the surface of the gingiva (the soft tissue) in order to inject a few drops of anaesthetic to produce localised infiltration anaesthesia at the spot where the perforator will be pushed through the gingiva and into contact with the cortical bone.

The perforator is used to drill through the cortical bone in order to provide access to the cancellous bone. On withdrawing the perforator, a 27 gauge ultra-short injection-needle, assembled with a standard syringe and carpule, is inserted in the perforation made in the cortical bone, and anaesthetic is injected into the cancellous bone, producing local anaesthesia within a short time, generally about 30 seconds.

Many dentists do not find any difficulty in bringing the needle into contact with the bone at the correct angle of inclination whereby the needle easily enters the drilled perforation. Other dentists, however, find that to advance the needle through the gingiva in line with the axis of the perforation is not easy. They tend to find that when they push the needle through the gingiva into contact with the bone they have to “hunt” for the perforation entrance, and in doing so the point of the bevel either sticks in the bone or bends into a “fish-hook” shape, and so will not enter the hole.

With the object of overcoming this difficulty, a system known by the trade mark X-Tip has been proposed and used in which the perforator is in two parts, an inner bevelled cannula of 27 gauge mounted on a plastic shank for rotation by a dental handpiece, and an outer bevelled cannula in which the inner cannula is slidably mounted. The outer cannula is secured to a plastic hub having a square cross-section which drivably engages with a corresponding square-walled cavity in the plastic shank associated with the inner cannula. When the handpiece is energised the inner cannula and the outer cannula rotate together to drill a hole through the cortical bone, the diameter of the hole being equal to the outside diameter of the outer cannula. The inner cannula is then withdrawn from the outer cannula, leaving the latter held in the bone, the plastic hub acting as a marker for the dentist when seeking to locate the injection-needle in the drilled hole.

In the X-Tip, however, locating the injection-needle in the outer cannula presents some difficulty because the lead-in to the outer cannula is limited to a shallow-angle flair at the end of the outer cannula. Furthermore, in the X-Tip there is the problem of achieving a satisfactory metal to metal fit between the outside diameter of the inner cannula and the bore of the outer cannula. If there is a sliding fit between the inner and outer cannulas, the outer cannula, unless carefully supported, may slide off the inner cannula while it is being brought into proximity with the patient's mouth. On the other hand, in the event of an interference fit between the inner and outer cannulas, the outer cannula could come away with the inner cannula, when the latter is being withdrawn after completing the drilling, and could fall into the patient's mouth unless the outer cannula is firmly held with cotton pliers or a haemostat. Furthermore, when it comes to the final step in the procedure, removing the outer cannula, it is often found that it has become wedged in the bone and that a haemostat or other instrument is needed in order to lever it out.

### SUMMARY

An object of the present invention is to overcome the above problems. According to the present invention, a guide sleeve device for use in insertion of a dental injection needle into a perforation in a cortical bone of a dental patient, sleeve device comprises:

a holding member including a finger grip part, adapted for gripping by fingers and a thumb of a dentist, and a funnel part, the funnel part having a flared portion and a cylindrical portion, the funnel part having an opening therethrough, the funnel part opening including a conical portion within the funnel part flared portion and a cylindrical portion within the funnel part cylindrical portion;

a guide sleeve including a flared part and a tubular part, the guide sleeve having an opening therethrough, the guide sleeve opening having a conical portion within the guide sleeve flared part and a cylindrical portion within the guide sleeve tubular part, the guide sleeve being within the holding member funnel part opening with the guide sleeve flared part within the conical portion of the funnel part opening and with the guide sleeve tubular part within the cylindrical portion of the funnel part opening. A retainer retains the guide sleeve within the holding member funnel part opening.

### BRIEF DESCRIPTION OF THE DRAWINGS

Further features of the invention will appear from the following description with reference to the accompanying drawings in which,

FIG. 1 is an elevation of a perforator of the kind shown in U.S. Pat. Nos. 5,057,013 and 5,057,050,

FIG. 2 is an elevation of a first embodiment of a guide-sleeve device in accordance with the present invention,

FIG. 3 is a top plan view of the guide-sleeve device shown in FIG. 2,

FIG. 4 is an enlarged sectional elevation of the guide-sleeve device taken along the line 4-4 in FIG. 3,

FIG. 5 is an elevation of a standard injection-needle, shown diagrammatically,

FIG. 6 is an elevation of a second embodiment of a guide-sleeve device in accordance with the present invention, partially in cross-section,

FIG. 7 is an elevation of a finger-grip part of the device of FIG. 6, the section being taken along line 7-7 of FIG. 8,

FIG. 8 is a top plan view of the finger-grip part of FIG. 7,

FIG. 9 is a sectional elevation of a guide sleeve portion of the device of FIG. 6, and

FIG. 10 is a bottom plan view of a modified embodiment of a finger-grip part of a guide sleeve device in accordance with the present invention.

### DETAILED DESCRIPTION

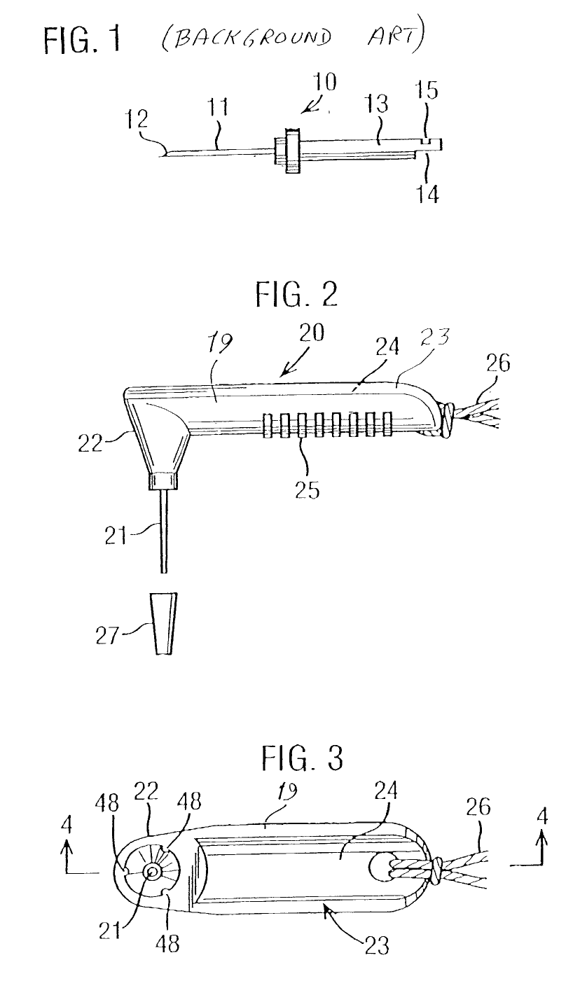

Referring now to FIG. 1, a perforator 10 of the type shown in U.S. Pat. Nos. 5,057,013 and 5,173,050 includes drilling means comprising a solid wire 11 of, for example, 23 gauge formed with a sharp bevelled end 12. The wire 11 is secured to a plastic shank 13 which at its free end is formed with a flat 14 and part-annular groove 15 for latching in a standard latch-type contra-angle dental handpiece (not shown). The perforator cap has been removed and is not shown.

Referring now to FIGS. 2 and 3 which show a first embodiment of the present invention, a guide-sleeve device 20 comprises a tubular guide-sleeve 21 of, for example, 23 gauge stainless steel, secured in a plastic funnel part 22 of a holding member 19. Funnel part 22 is of hollow conical form. Integrally moulded with the funnel part 22 is a finger-grip part 23 extending laterally from the mouth of the funnel part at about 90 degrees to the axis of the funnel for a distance in excess of about one-quarter of an inch. The finger-grip part 23 may have a concave surface 24 on one side and a series of serrations 25 on a convex surface on the other side. A safety-cord 26 of, for example, cotton is attached to the free end of the finger-grip part 23. A plastic cap 27, closed at one end, and shown removed from the guide-sleeve device, may be placed over the free end of the guide-sleeve after manufacture, to protect against possible damage to the packaging during shipment.

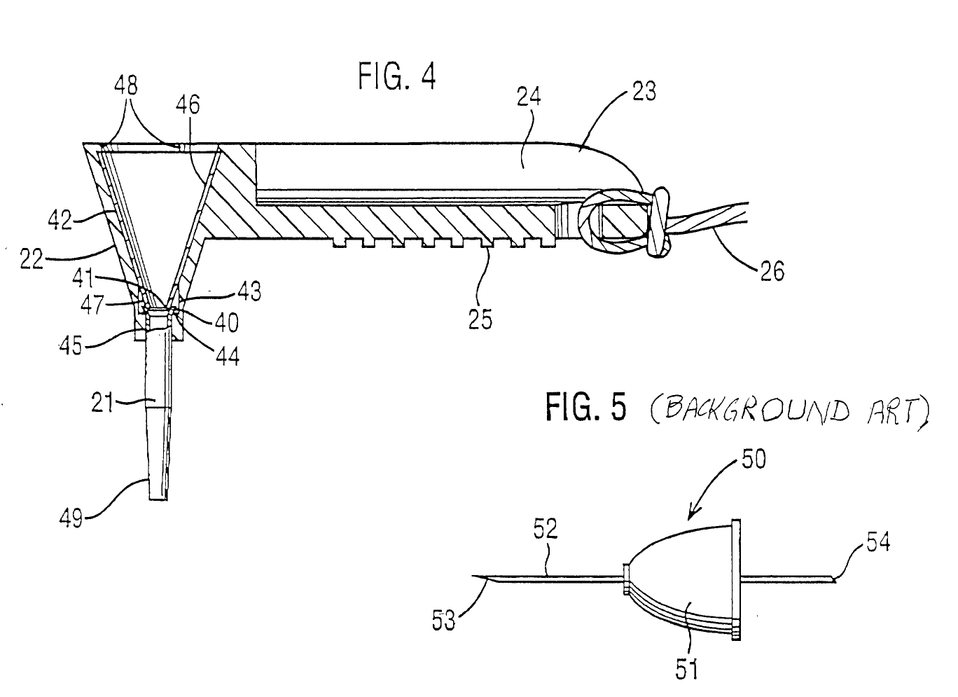

Referring now to FIG. 4, the guide-sleeve 21 has a flared end 40 having an inner conical surface 41. The funnel part 22 has an interior conical surface 42. The interior conical surface 42 at its converging end may merge with an annular cut-away portion 43 having a shoulder 44 on which the flared end 40 of the guide-sleeve 21 seats. The cut-away portion 43 of the funnel 22 terminates at its inner end in a circular cylindrical portion 45 which steadies the connection of the guide-sleeve 21 on the funnel part 22.

A frusto-conical shaped liner 46, made of, for example, stainless steel or brass of 0.25 mm thickness, is assembled over the interior conical surface 42 of the funnel part 22. The converging end 47 of the liner 46 bears against the inner surface 41 of the flared end 40 of the guide-sleeve 21, retaining the guide-sleeve against movement out of the funnel part 22. The small thickness of the liner 46 permits a smooth ride of the injection-needle as the tip of the bevel of the needle passes from the liner 46 to the flared end 40 of the guide-sleeve, as further described hereinafter. The larger diameter end of the liner 46 is a snap fit beneath a circumferential lip 48 formed at the larger diameter end of the plastic funnel part 22, retaining the assembly together.

The free end of the guide-sleeve 21 has a shallow conical taper 49 formed on its external surface, extending for example about halfway along the length of the guide-sleeve 21 and terminating in a stub, i.e. without a sharp point. The angle of conical taper is limited because of the very small wall thickness.

Referring to FIG. 5, a standard 30 gauge injection-needle 50 (with both caps removed and not shown) comprises a plastic hub 51 secured to a 30 gauge cannula 52, one bevelled end 53 of which providing the outlet for the anaesthetic, while the other bevelled end 54 is connectible in known manner with a standard cartridge of anaesthetic (not shown).

In operation, the perforator 10 of FIG. 1 is operated as described in U.S. Pat. Nos. 5,057,013 and 5,173,050, to make a perforation through the cortical plate. After withdrawing the perforator from the bone, the guide-sleeve device 20 is manually inserted into the perforation in the cortical plate. The finger grip part 23 may be held between the thumb and forefinger during this step.

The guide-sleeve 21 is pushed home in the perforation until the plastic funnel part 22 comes into engagement with the attached gingiva. The frictional resistance between guide-sleeve 21 and the bore of the perforation is sufficient to retain the guide-sleeve in place in the cortical bone.

The plastic funnel 22 acts as a marker for the dentist when bringing the injection-needle into proximity with the perforation. The dentist places the free end of injection-needle 50, assembled in well-known manner with a standard cartridge and syringe, within the relatively wide (about one-eighth of an inch) mouth of the cavity of the metal liner 46. As the dentist advances the needle 50 towards the guide-sleeve, the sharply bevelled end of the needle engages and slides along the surface of the metal liner 46, smoothly rides over onto the inner surface 41 of the flared end 40 of the guide-sleeve 21 and leads the main body of the needle into the circular cylindrical portion of the guide-sleeve. The wide entrance to the liner makes placing the needle in the guide-sleeve 21 particularly easy.

After injecting anaesthetic, the injection-needle is removed from the guide-sleeve 21 and then the guide-sleeve device 20 itself is removed from the perforation in the cortical plate, the finger grip part 23 providing a convenient handle for effecting the withdrawal of the guide-sleeve without any need for a haemostat.

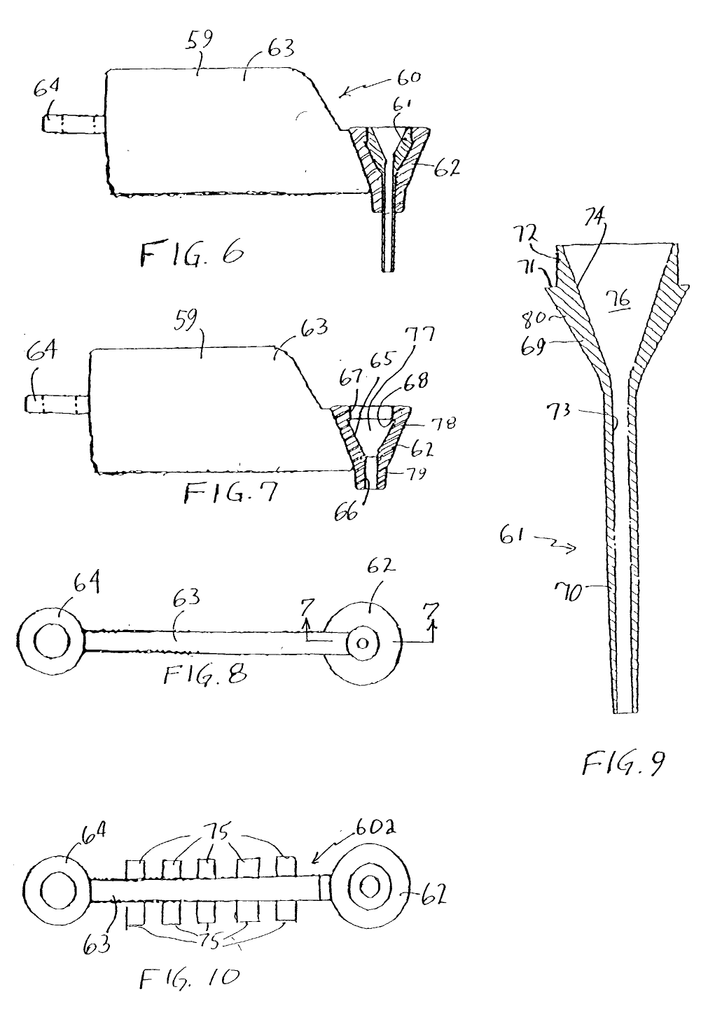

Referring now to FIGS. 6-10 which show a second embodiment of the present invention, a guide-sleeve device 60 comprises a tubular guide-sleeve 61 secured in a funnel part 62 of a holding member 59. Funnel part 62 includes a flared portion 78 and a cylindrical portion 79. A finger-grip part 63 extends laterally from funnel part 62 at about 90 degrees to the axis of the funnel part. The finger-grip part 63 is preferably a relatively thin blade-like member extending laterally from funnel part 62 a distance of, for example, in excess of about one-quarter of an inch in a plane parallel with the central axis of funnel part 62, and might have a height of, for example, in excess of about one-eighth of an inch. On the end of finger-grip part 63, opposite funnel part 62, an annular part 64 is provided for attachment of a safety-cord, as in the embodiment of FIGS. 2-4. Finger grip part 63 might be formed of a suitable plastic, for example by a moulding process.

Funnel part 62 has a central opening 77 which includes an interior conical surface 65, the converging end of which merges with a circular cylindrical portion 66. A second cylindrical portion 67 of opening 77 passes through the upper end of funnel part 62 to meet conical surface 65 at a shoulder 68.

Referring know to FIG. 9, guide-sleeve 61 has a flared part 69 and a tapered tubular part 70. Flared part 69 includes a conical portion 80 which merges with a cylindrical end portion 72 at a shoulder 71. A central opening 76 passes through guide sleeve 61 and includes a cylindrical portion 73 within tubular part 70 and a conical portion 74 within flared part 69.

Flared part 69 of guide-sleeve 61 is sized to fit firmly within funnel part 62 of holding member 59. Tubular part 70 preferably has a shallow conical taper formed on its external surface, extending for example about halfway along the length of the tubular part and terminating in a stub. Tubular part 70 has a bore corresponding with the outside diameter of the dental injection needle; i.e. sized to permit the needle to be inserted and withdrawn, while preventing leakage of the anaesthetic. Guide sleeve 61 is preferably formed of metal, for example stainless steel or brass, and may be formed by machining.

To assemble guide-sleeve device 60, the lower end of tubular part 70 of guide-sleeve 61 is inserted into opening 67 of funnel part 62 of holding member 59 and through cylindrical opening 66. Funnel part 62 has sufficient resilience to permit flared part 69 of guide sleeve 61 to deform the material so that flared part 69 pushes through opening 67 until shoulder 71 of guide-sleeve 61 snaps beneath shoulder 68 of funnel part 62, as depicted in FIG. 6.

FIG. 10 is top plan view of a slightly modified embodiment of a guide-sleeve device 60a which differs from guide-sleeve device 60 by the inclusion of a number of serrations 75 on the sides of finger-grip part 63 to enhance the ability of the dentist to grip the guide-sleeve device. These serrations may extend from the sides of finger-grip part 63 as depicted in FIG. 10, or they may be indentations into the sides. Preferably the serrations extend vertically over a substantial portion of the height of the finger-grip sides, although they may be formed as bumps or dimples.

The manual insertion of the guide-sleeve in the bone perforation is much easier to perform than the insertion of the needle in the bone perforation as described in U.S. Pat. Nos. 5,057,013 and 5,057,050. This is because there is no need to form the guide-sleeve with a sharply ended bevel at its free end as in the case of a needle which is going to be used first to anaesthetise the gingiva by infiltration and then to anaesthetise the tooth by intraosseous injection through the cancellous bone. The conical, stub-ended, free end of the guide-sleeve can readily find the incision in the gingiva where the perforator was pushed through into contact with the bone and can then be easily moved the short distance laterally along the bone surface to find the entrance to the perforation without sticking in the bone or fishtailing. The conical shape of the free end of the guide-sleeve aids self-centering into the perforation. Furthermore, the compact form of the guide-sleeve device and its easy handling by means of the finger-grip part also assist the locating and insertion of the guide-sleeve in the perforation and are in contrast with the more cumbersome assembly comprising the injection-needle, cartridge and syringe used to carry out the final stage of the injection of anaesthetic into the cancellous bone.

The safety cord 26 is an additional safety measure for providing security in the unlikely event of the guide-sleeve device being dropped into the patient's mouth during handling. The safety-cord can be added because the guide-sleeve device, unlike in the case of the X-Tip, is not mechanically rotated during its insertion.

The present invention thus provides an improved guide-sleeve device, enabling a dentist to readily insert a dental injection needle into a perforation that has been drilled in a patient's cortical bone so as to inject anaesthetic. Although the invention has been described with reference to preferred embodiments, various alterations, rearrangements, and substitutions could be made, and still the result would be within the scope of the invention.

What is claimed is:

1. A guide sleeve device for use in insertion of a dental injection needle into a perforation in a cortical bone of a dental patient, said guide sleeve device comprising:
a holding member including a finger grip part, adapted for gripping by a finger and a thumb of a dentist, and a funnel part, the funnel part having a flared portion and a cylindrical portion, the funnel part having an opening therethrough, the funnel part opening including a conical portion within the funnel part flared portion and a cylindrical portion within the funnel part cylindrical portion; and
a guide sleeve including a flared part and a tubular part, the guide sleeve having an opening therethrough, the guide sleeve opening having a conical portion within the guide sleeve flared part and a cylindrical portion within the guide sleeve tubular part, the guide sleeve being within the holding member funnel part opening with the guide sleeve flared part within the conical portion of the funnel part opening and with the guide sleeve tubular part within the cylindrical portion of the funnel part opening,
the holding member including a retainer for retaining the guide sleeve within the holding member funnel part opening.

2. A guide sleeve device as claimed in claim 1, wherein:
the guide sleeve flared part has a converging end and the guide sleeve tubular part has a flared end, the guide sleeve flared part converging end bearing against the guide sleeve tubular part flared end inside the holding member funnel part opening cylindrical portion; and
the holding member funnel part opening has an upper lip retaining the guide sleeve within the funnel part opening.

3. A guide sleeve device as claimed in claim 1, wherein:
the holding member funnel part opening further includes a second cylindrical portion merging with the upper end of the funnel part opening conical part to provide a first shoulder;
the guide sleeve flared part includes a cylindrical end portion and a conical portion, the guide sleeve flared part cylindrical end portion extending from the guide sleeve flared part conical portion at a second shoulder; and
the guide sleeve flared part cylindrical end portion is within the holding member funnel part opening second cylindrical portion, the guide sleeve flared part conical portion is within the holding member funnel part opening conical portion, and the second shoulder is abutting the first shoulder, retaining the guide sleeve within the holding member funnel part.

4. A guide sleeve device as claimed in claim 1, wherein the guide sleeve tubular part is tapered from a larger outside diameter adjacent the guide sleeve flared part to a smaller outside diameter remote from the guide sleeve flared part.

5. A guide sleeve device as claimed in claim 1, wherein the holding member further includes a part adapted for attachment thereto of a safety cord.

6. A guide sleeve device as claimed in claim 1, wherein the holding member finger-grip part includes serrations to aid in gripping of the guide sleeve device by the dentist.

7. A guide sleeve device for use in insertion of a dental injection needle into a perforation in a cortical bone of a dental patient in order to deliver intraosseous anaesthesia, said guide sleeve device comprising:
a holding member including a finger grip part, adapted for gripping by a finger and a thumb of a dentist, and a funnel part for acting as a marker for the dentist when bringing the dental injection needle into proximity with the perforation, the funnel part defining a frusto-conical cavity; and
a guide sleeve including a circular cylindrical tube part and a flared part merging with one end of the tube part, the tube part having a bore corresponding with the outside diameter of the dental injection needle, the flared part, being disposed within the holding member funnel part so as to permit the dental injection needle to be advanced within the funnel part into engagement with and movement over the flared part so as to lead an end of the dental injection needle into the circular cylindrical tube part of the guide sleeve.

8. A guide sleeve device as claimed in claim 7, wherein:
the frusto-conical cavity is lined with a metal liner, the metallic liner engaging with a flared part of the circular cylindrical tube part to permit a smooth passage of the end of the needle along the surface of the liner and onto the surface of the flared part of the tube part.

9. A guide sleeve device as claimed in claim 7 wherein:
the flared part of the guide sleeve covers a major portion of the wall of the frusto-conical cavity.

10. A guide sleeve device as claimed in claim 7, wherein:
the guide sleeve flared part comprises a metal liner lining the frusto-conical cavity and engaging with an end of the circular cylindrical tube part to permit a smooth passage of the end of the needle along the surface of the liner and onto the surface of the tube part.

11. A guide sleeve device according to claim 7, wherein:
the circular cylindrical tube part of the guide sleeve has at its free end an exterior surface with a conical taper.

12. A guide sleeve device according to claim 7, wherein:
the finger grip part is in the form of a blade extending laterally from the funnel part in excess of one-quarter of an inch in a plane parallel with the axis of the tube part and has a height in excess of one-eighth of an inch.
